(19) United States
(12) Patent Application Publication
(10) Pub. No.: US 2010/0325981 A1
(43) Pub. Date: Dec. 30, 2010

(54) Mounting device for a glazing panel and method of its use

(76) Inventors: Brandon Snyder, Lykens, PA (US); William Bezubic, Millersburg, PA (US)

Correspondence Address: SILBER & FRIDMAN, 1037 ROUTE 46 EAST, SUITE 207, CLIFTON, NJ, 07013, US

(21) Appl. No.: 12/459,174

(22) Filed: Jun. 26, 2009

(51) Int. Cl. E06B 3/968; E06B 3/58

(52) U.S. Cl. 52/204.62; 52/656.5; 52/745.15

(57) ABSTRACT

A mounting device is provided for holding a glazing panel against a supporting structure. The mounting device consists of a base having a plurality of spaced-apart support members. The base and support members defining a base plane. A restricting structure spaced from the base extends within a restricting plane transversely to the supporting plane. The glazing panel is disposed within the base plane and is supported by the base and support members.

### FIELD OF INVENTION

The present invention relates in general to manufacturing and installation of glazing units, and more specifically it relates to mounting devices and method for installation and holding glazing units against a supporting structure.

### BACKGROUND OF THE INVENTION

Glazing units such as glazed windows and doors used for wall and roof constructions must be capable of resisting both the static and dynamic loads as well as the impact loads to which they will be subjected. Principle wall and roof loads are created by high winds, and in the northern climates, by snow and ice. The evaluation of pressures exerted by wind on a building is complex, and local code requirements for wind forces can vary widely depending on the weather extremes expected in the area. The recommended design wind pressure on plane surfaces which are normal to the wind, increases with the height of the structure above ground level. Wind may also produce suction or pressure depending on configuration of the walls and the roof.

Swirling winds against building structures can cause damage by penetrating building envelopes such as by breaking windows due to flying debris or high wind pressure allowing wind to rush into the houses and buildings pressuring the interior thereof. The vacuum caused by high winds rushing over the walls and roof in conjunction with the pressurized interior of the houses and buildings can cause substantial damage to the supporting structure. In extreme weather regions, such as in the hurricane ravaged areas of Florida, rigorous testing standards are being employed in new building codes to address the structural damage caused by hurricanes due to inadequate building construction. Thus, the challenge for the construction industry is to provide glazing units, such as windows, doors, etc. that meet the industry requirements.

One of the problems which causes inadequate building and house construction is due to poor retention of the glazing panels within the respective window and door structures which is due to inadequate amount of glazing compound or sealant which is provided in manufacturing of the glazing units. In manufacturing of the glazing units known in the prior art, weight of the glass panels provides a substantial pressure on an unsolidified sealant or glazing compound disposed in the receiving structures of the glazing frames. In this manner, in the prior art sealant or glazing compound is often squeezed out leaving a minimal amount thereof for the anchoring purposes. Such limited amount of sealant is often not enough to properly secure the glazing panel or glass within the frame. This causes highly undesirable separation of the glazing panels or glass from the respective frame. Such situations are specifically exacerbated in the localities exposed to the extreme whether conditions discussed hereinabove.

Another problem encountered by the prior art structures is utilization of materials which are not fully compatible with glazing compounds. In such instances, sealant is often ripped or torn in many areas causing highly undesirable separation of the glazing panels from the support structures.

Thus, it has been a long-felt and unsolved need for a device and method of manufacturing and installation of glass units resulted in the improved holding of the glazing panels and the supporting structure, and also provides a better compatibility with a sealant.

### SUMMARY OF THE INVENTION

One aspect of the invention provides a mounting device for holding a glazing panel securely against a supporting structure in a predetermined orientation within the mounting device being supported by the supporting structure, so as to fit between the supporting structure in a glazing panel. The device consists of a base, a plurality of spaced-apart supporting members extending outwardly therefrom in the first direction. The base and support members defining a substantially base plane. The restricting structure is spaced from the base and extends within the restricting plane transversely to the supporting plane. The glazing panel is disposed within the supporting plane, so as to be supported by the base and support members.

As to another aspect of the invention, the restricting structure restricts longitudinal motion of the glazing panel and prevents contacts between the glazing panel and the respective portion of the supporting structure. The at least one connecting member consists of a plurality of spaced from each other connecting members extending from the base in the second direction which is opposite to the first direction, so as to define a gap between the base and the restricting structure. The restricting structure comprises at least a pair of restricting elements separated by an intermediary element, so that the restricting structure is formed having a C-shaped configuration and the restricting and intermediary elements define the restricting plane which is transverse to the base plane.

As to a further aspect of the invention, each support member extends between a proximal end connected to the base and a free distal end. The engaging formation having a substantial outer periphery is provided at the distal end of each support member so as to engage the glazing panel. A gap is formed between the connecting elements, the intermediate element and the restricting portion of the base member. The restricting structure can be connected to the base member by a multiplicity of the connecting elements, so as to form a plurality of the gaps between the base structure and the restrictive structure.

As to still another aspect of the invention, an operational space is formed between the glazing panel and the supporting structure. The operational space is a function of an outer periphery of the engaging formations.

As to still further aspects of the invention, in an assembled condition, the mounting device absorbs and re-distributes the weight of the glazing panel from the glazing compound to the support plane of the device and to the limited area of the outer periphery of the engaging formations. In this manner, in the assembled condition of the invention, an unsolidified glazing compound enters spaces between the support members and the gaps between the base member and the restricting structure, so as to enhance anchoring of the mounting device and the glazing panel within the support structure.

As to a further aspect of the invention, the mounting device of the invention is made of a material which is fully compatible with silicone sealants and other glazing compounds, so as to provide a better adhesion between a glass sealant and the entire support structure.

### BRIEF DESCRIPTION OF THE DRAWINGS

FIG. 1 is a perspective view showing the mounting device of the invention;

FIG. 2 is a top plan view thereof;

FIG. 3 is a front elevational view thereof;

FIG. 4 is a partial side elevational view thereof;

FIG. 5 is a perspective view of another embodiment of the mounting device of the invention;

FIG. 6 is a top plan view thereof;

FIG. 7 is a front elevational view thereof;

FIG. 8 is a side elevational view thereof;

FIG. 9 is a sectional view of an assembly utilizing the mounting device of the invention; and

FIG. 10 is an exploded view of an assembly utilizing the mounting device of the invention.

### DETAILED DESCRIPTION OF THE INVENTION

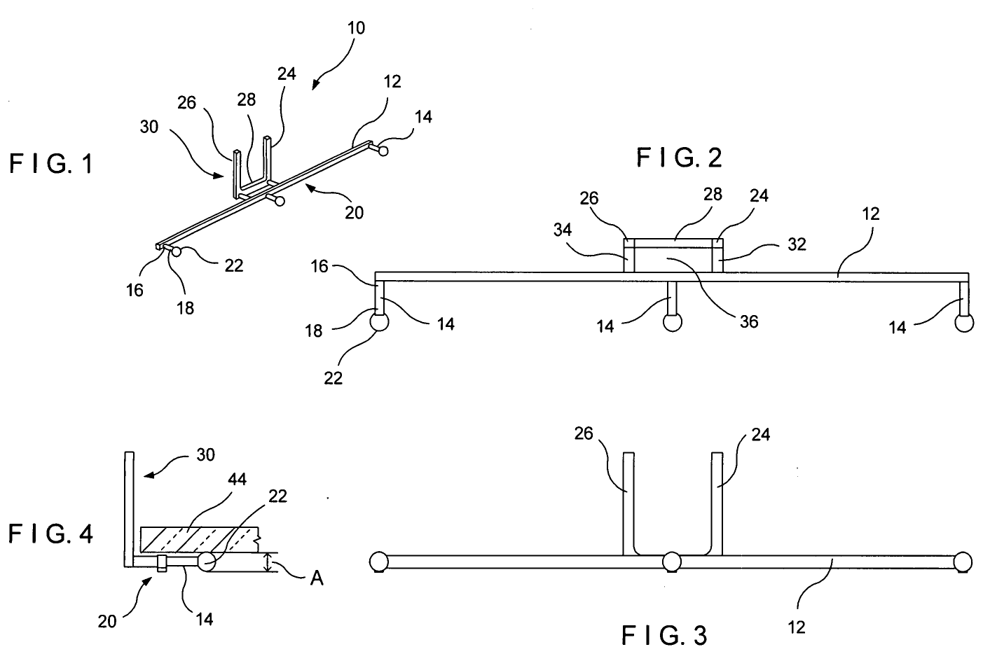

Referring now to the drawings in general and to FIGS. 1-4 in particular illustrating a preferred embodiment of the mounting device 10 of the invention. The device is formed by a base structure 20 and a restricting structure 30 positioned at an angle to each other. As to the base structure, an elongated base member 12 is disposed along a longitudinal axis of the device with a plurality of support members 14 extending outwardly from the base 12 in a spaced-apart relationship. A proximal end 16 of each support member is connected to the base 12 with an engaging formation 22 being provided at a distal free end 18 thereof. In the embodiment of FIG. 1, the base 12 and the support members 14 are formed having elongated straight-forward configuration. It should be noted however, that the base and support members having curved or any other conventional configuration are also contemplated. As illustrated in FIG. 1, the engaging formations 22 are shaped having a semi-spherical configuration with the respective support members 14 being attached to their central parts. Other shapes of the engaging formations, such as elliptical cubical, pyramidal, etc. are also within the scope of the invention.

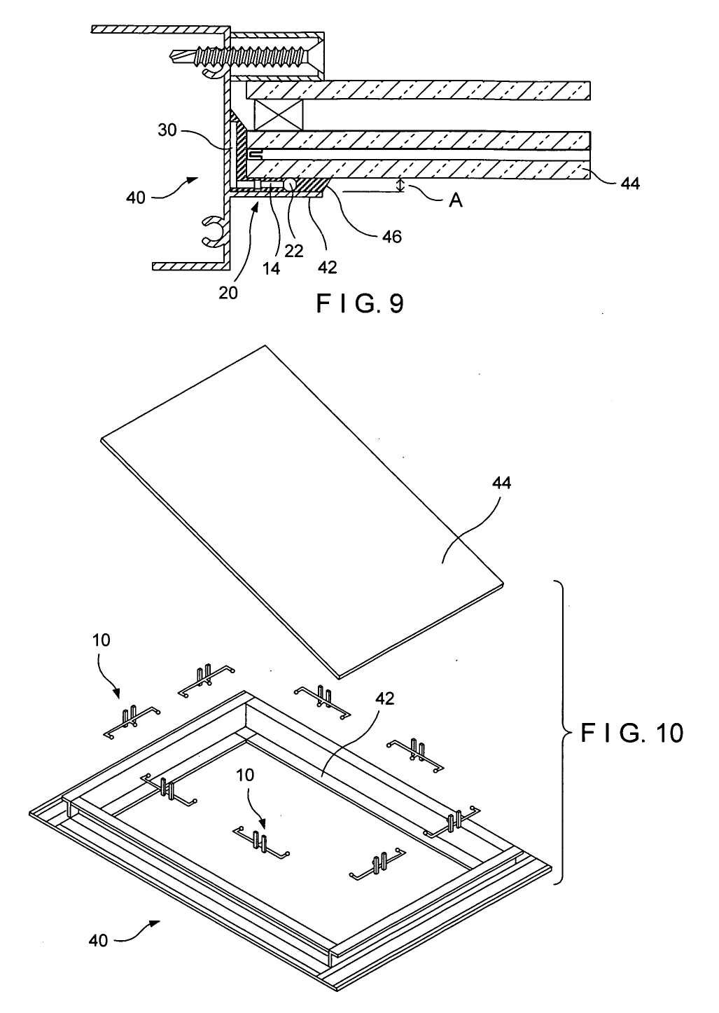

A base plane of the device, which is adapted to receive and support the respective glazing panel, passes substantially through the base member 12 and support members 14 including the engaging formations 22. It will be discussed hereinbelow that the diameter or an outer periphery of the engaging formations 22 is indicative of and control the operational space “A” between the glass panel and the frame of support structure (see FIG. 9). In the same manner, the operational space “A” controls the amount of sealant that is retained between the glass panel and the frame in the assembled condition. By varying diameter, shape or size of the outer periphery of the engaging members 22, the dimensions of the operational space “A” can be also varied. It will be discussed below that in the situations where a substantial amount of sealant for retaining the glass panel is required, the engaging formations 22 having larger diameter should be used. On the other hand, in order to reduce the amount of sealant between the glass panel and the frame, the engaging formations 22 with smaller diameter are applicable.

The restricting structure 30 is spaced from the base member 12 of the support structure and extends within a restricting plane oriented transversely to the base plane of the device. In the embodiment of FIG. 1, the restricting structure 30 is formed by at least two spaced from each other restricting elements 24 and 26 connected by an intermediary element 28. In this fashion, the restricting structure having a substantially C-shaped configuration is provided. The restricting plane passes through the restricting and intermediary elements 24, 26, 28 and extends transversely to the support plane of the device. The restricting structure 30 is spaced from and connected to the base member 12 by at least one connecting element 32. In the embodiment of FIG. 1, at least one connecting element is a pair of connecting elements 32 and 34 which extend from the base 12 in the second direction, which is opposite to the first direction of the support members. In this manner, a gap 36 is formed between the connecting elements 32, 34; the intermediate element 28 and the respective portion of the base member 12. The function of the gap 36 will be discussed hereinbelow.

Although, in the preferred embodiment, the restricting structure 30 is formed by a pair of spaced-apart restricting elements 24 and 26. It should be noted that the extension of the intermediary element 28, so as to accommodate a greater plurality of the restricting elements is also contemplated. In such embodiment, the restricting structure is connected to the base member 12 by a greater multiplicity of the connecting elements. In this manner, a plurality of the gaps 36 between the base structure 20 and the restricted structure 30 are formed.

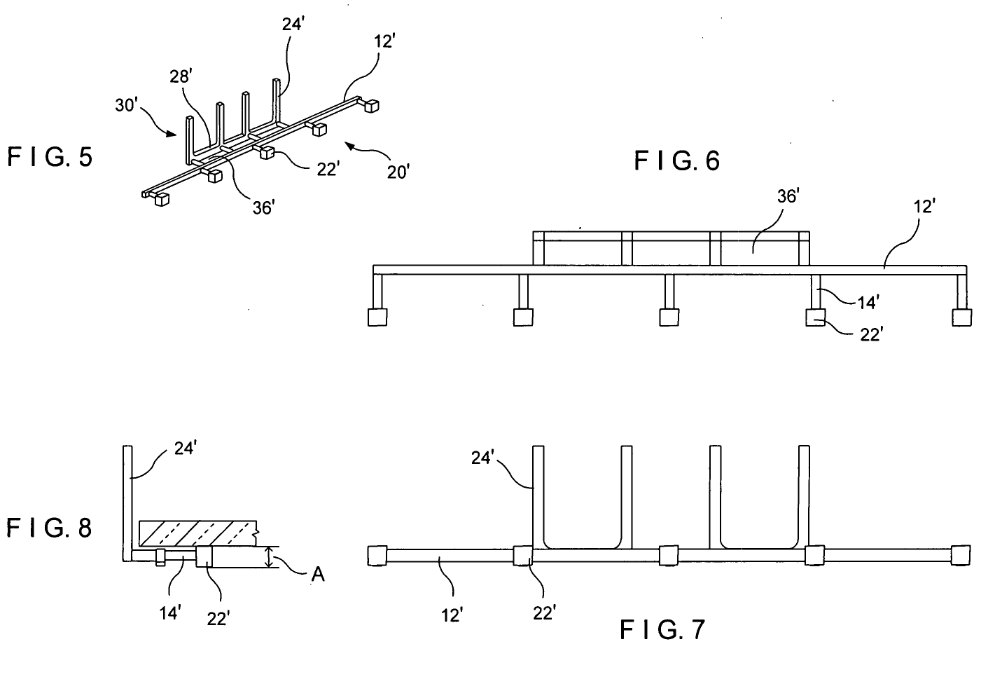

The above-discussed alternate embodiment of the mounting device of the invention is illustrated in FIGS. 5-8. As to the support structure, the elongated base member 12′ accommodates a greater plurality of the support members 14′. The engaging formations 22′ are disposed at the distal ends of the support members and are shown to have cubical configuration. The restricting structure is formed by a plurality of the restricting elements 24′ which extend outwardly from the intermediary element 28′ having greater length than that of the embodiment of FIGS. 1-4. A multiplicity of the gaps 36′ is formed between the support and restricting structures. The lateral extend of the device depends on the number of glass panels, spaces and glass thickness especially when multiple glaze units are mounted.

In the preferred embodiment, the mounting device of the invention is made of a hydroscopic material which is fairly soft in durometer, such as Nylon for example. Nylon is also compatible with silicone sealants and other glazing compounds utilized in the industry. A hydroscopic nature of Nylon is also advantageous since it can absorb about 1-1.5% of moisture depending on how it is compounded. This is important since hydroscopic cure is a part of the mechanism of formation of glazed units utilizing the mounting device of the invention. In other words, Nylon provides better adhesion to the silicone based glazing compound, so as to assure minimal separation between the glass and the glazing rebate or sealant. Although use of Nylon has been described hereinabove, it should be obvious to a person of ordinary skill in the present art that the device of the invention can be manufactured from other materials which are soft in durometer, compatible with glazing compounds and/or hydroscopic, such as plastics, etc.

Referring to now FIGS. 9 and 10 illustrating use of the mounting device of the invention. When mounting a glazed unit in a window or sash frame, and to establish a required contact, a supporting structure 40 such as for example, a window or door frame is horizontally positioned on a substantially flat surface. In such position, an area of a glazing leg or receiving flange 42 of the frame adapted for receiving the glass or glazing panel 44 faces upwardly. An ample amount of wet or unsolidified sealant or glazing compound 46 is applied to the flange area 42 of the frame provided for receiving the glazing panel. Unsolidified glazing compound 46 is then spread on the frame shoulder and other areas. A multiplicity of the mounting devices 10 of the invention are then placed within the glazing compound disposed along the periphery of the glazing leg or flange 42. In this position as illustrated in FIG. 9, for each mounting device, the base member 12 and the support members 14 are positioned at the top surface of the receiving flange 42 and the restricting structure 30 is disposed at the vertical wall of the frame. Then the glass or glazing panel 44 is placed into the frame and it is supported by the multiple mounting devices 10 of the invention. In this position, the glass panel 44 faces the base 12 and support members 14, and engages the outer periphery to the engaging formations 22.

As clearly illustrated in at least FIG. 9, in view of relatively large diameter of the engaging formation 22 compared to the thickness of the support members 14, an area of engagement between the glazing panel 44 and the mounting device is substantially limited. The operational space “A” between the outer surface of the glazing panel 44 and the flange 42 assures that a proper distance is retained to keep the glazing panel 44 away from the frame 40. In this manner, enough quantity of the glazing compound 46 is accommodated and retained between the receiving flange 42 of the frame and the glazing panel 44. The plurality of the mounting devices 10 situated through the periphery of the flange 42 absorbs and re-distributes the weight of the glazing panel 44 from the glazing compound 46 to the supporting plane of the mounting devices 10 in general and specifically to the limited area of the outer periphery of the engaging formations 22. Thus, the pressure generated by the weight of the glazing panel 44 does not squeeze out an unpredictable amount of the unsolidified glazing compound from the area between two surfaces. Under the weight of the glazing panel 44, an unsolidified glazing compound flows around and enters the spaces between the support members 14, as well as enters the gaps 36 between the respective base members 12 and the restricting structures 30. The liquefied glazing compound actually extends within the gaps 36 providing better anchoring between the frame and the glazing panel after the compound is solidified. This substantially improves anchoring of the mounting devices 10 and the glazing panels within the glazing compound further improving quality of the assembly.

In the prior art a substantial weight of the glass panels applies a great deal of pressure on the unsolidified sealant disposed on the receiving flange or glazing leg of the frame. In this manner, a sealant or glazing compound is squeezed out leaving a minimal amount thereof for the anchoring purposes. Such minimal amount of sealant is often not enough to properly secure the glass to the frame. Upon the plurality of mounting devices 10 of the invention being installed into the unsolidified glazing compound sealant, it is assured that the proper amount of sealant is retained throughout periphery of the frame. Without the device of the invention, as often occurs in the prior art, a substantial weight of the glazing panel applies a pressure against the wet silicone glazing compound to squeeze it out and to leave a very limited amount thereof for the anchoring purposes. In the prior art, a user is often left with an unsatisfactory amount of wet silicone glazing compound between the glass and frame. With the plurality of mounting devices of the invention, a proper distance or the operational space “A” is established to hold the glass panel 44 away from the frame 42, 40 so as to retain an ample amount of sealant between two surfaces. When the plurality of mounting devices are in place, their purpose is to retain a proper space between the glass and the frame to ultimately accommodate a proper amount of sealant or back bedding material between the frame and glass panel.

What is claimed is:

1. A mounting device for holding a glazing panel against a supporting structure in a predetermined orientation with the mounting device being supported by the supporting structure and fit between the supporting structure and the glazing panel, the mounting device comprising:
a base, a plurality of spaced apart support members extending outwardly therefrom in the first direction, said base and support members substantially defining a base plane;
a restricting structure spaced from the base and extending within a restricting plane transverse to the supporting plane; and
said glazing panel being disposed within the base plane and is supported by the base and support members.

2. The mounting device of claim 1, wherein said restricting structure restricts longitudinal motion of the glazing panel and prevents contacts between the glazing panel and respective portions of the supporting structure.

3. The mounting device of claim 1, wherein the restricting structure is connected to the base by at least one connecting member.

4. The mounting device of claim 3, wherein said at least one connecting member comprises at least two connecting members spaced from each other, said at least two connecting members extending from the base in the second direction opposite to the first direction, so as to define at least one gap between the base and the restricting structure.

5. The mounting device of claim 4, wherein said restricting structure comprises at least two restricting elements separated by an intermediary element, so that said restricting structure is formed having a C-shaped configuration, and the restricting and intermediary elements define the restricting plane which is transverse to the base plane.

6. The mounting device according to claim 1, wherein each support member extends between a proximal end connected to the base and a free distal end, an engaging formation having an outer periphery is provided at the distal end of each said support member, said outer periphery of the engaging formation being greater than the thickness of the respective support member.

7. The mounting device of claim 1, wherein said base and support members have a curved configuration.

8. The mounting device of claim 6, wherein said gap is formed between the connecting elements, the intermediate element and the respective portion of the base member.

9. The mounting device of claim 8, wherein the restricting structure is connected to the base member by a multiplicity of the connecting elements, so as to form a plurality of said gaps between the base structure and the restrictive structure.

10. The mounting device of claim 6, wherein each said engaging formation is formed having a semi-spherical configuration with the respective support members is attached to central area of the engaging formation.

11. The mounting device of claim 6, wherein an operational space is formed between the glazing panel and the supporting structure, said operational space corresponding to the outer periphery of said engaging formation.

12. The mounting device of claim 6, wherein said engaging formation has a shape selected from the group including cubical, pyramidal, conical and other configurations.

13. The mounting device of claim 6, wherein in an assembled condition, the mounting device absorbs and re-distributes the weight of the glazing panel from the glazing compound to the limited area of the outer periphery of the engaging formations.

14. The mounting device of claim 13, wherein in the assembled condition an unsolidified glazing compound enters spaces between the support members and the gaps between the base member and the restricting structure, so as to enhance anchoring of the mounting device and the glazing panel within the support structure.

15. A method of mounting a glazing panel within a supporting structure by means of mounting devices each comprising a base, a plurality of spaced-apart support members extending outwardly therefrom in the first direction, an engaging formation being provided at a free end of each support member, an outer periphery of said engaging formation being greater than the thickness of the respective support member, in each said mounting device a restricting structure is spaced from the base, and the restricting structure is connected to the base by the connecting members spaced from each other so as to define a gap between the base and the restricting structure, said method comprising the steps of:
positioning of the support structure in such a manner that a receiving area or receiving flange thereof faces outwardly so as to receive the glazing panel;
applying an ample amount of unsolidified glazing compound to said receiving flange;
positioning at least one mounting device within said unsolidified sealant in such a manner that the base member and support members are positioned at the top of the receiving flange; and
positioning the glazing panel within the supporting structure in such a manner that the outer surface of the glass panel faces the base and the support members engaging the outer periphery of the engaging formations.

16. The method of claim 15, wherein an operational space if formed between the outer surface of the glass panel and the receiving flange area of the support structure, said operational space corresponds to an outer periphery of the engaging formation.

17. The method of claim 16, wherein at least one mounting device is a plurality of the mounting devices being distributed along the periphery of the receiving area, so that in each said mounting device the base structure including the base and the support members are positioned at the top of the receiving flange and the glazing panel faces the base and support members engaging the outer periphery of the engaging formations.

18. The method of claim 17, wherein the plurality of mounting devices absorbs and redistributes the weight of the glazing panel from the glazing compound to the limited area of the outer periphery of the respective engaging formations, so that under the weight of the glazing panel, the unsolidified glazing compound enters the spaces between the support members and also enters the gaps between the base member and the restricting structure to enhance anchoring of the mounting devices and the glazing panel within the glazing compound and the supporting structure.

19. The mounting device of claim 1, wherein the device is made of a material which is substantially soft in durometer, compatible with sealants and other glazing substances and is hydroscopic in nature.

20. The mounting device of claim 19, wherein the device is made of Nylon.
